(19) United States
(12) Patent Application Publication
(10) Pub. No.: US 2024/0334201 A1
(43) Pub. Date: Oct. 3, 2024

(54) METHOD AND APPARATUS FOR AI/ML MODEL MONITORING

(71) Applicant: Erdem BALA, San Mateo, CA (US)

(72) Inventor: Erdem BALA, San Mateo, CA (US)

(21) Appl. No.: 18/020,186

(22) PCT Filed: Jan. 18, 2023
(86) PCT No.: PCT/US2023/010999

§ 371 Date: Feb. 7, 2023

(51) Int. Cl. H04W 24/02; H04B 7/06

(52) U.S. Cl. CPC H04W 24/02; H04B 7/0626

(57) ABSTRACT

A method performed by at least one processor of a user equipment (UE) includes receiving a set of resources from a base station. The method includes performing a first measuring of the set of resources based on a legacy mode that does not use an artificial intelligence machine learning (AI/ML) model to produce a first output. The method includes performing a second measuring of the set of resources based on the AI/ML model to produce a second output. The method includes reporting, to the base station, results corresponding to the first output and the second output.

### CROSS-REFERENCE TO RELATED APPLICATIONS

This application claims priority U.S. Provisional Application No. 63/421,724, filed on Nov. 2, 2022, the disclosure of which is incorporated herein by reference in its entirety.

### FIELD

Apparatuses and methods consistent with example embodiments of the present disclosure relate to an artificial intelligence machine learning (AI/ML) model performance monitoring, and more particularly to AI/ML model performance monitoring with respect to Radio Access Network (RAN) procedures.

### BACKGROUND

Currently, a 3GPP framework for an AI/ML model for an air-interface corresponding to each target use case regarding aspects such as performance, complexity, and potential specification impact is being explored. Some of these use cases focus on channel state information (CSI) feedback enhancement (e.g., overhead reduction, improved accuracy, prediction), beam management (e.g., beam prediction in time, and/or spatial domain for overhead and latency reduction, beam selection accuracy improvement), and positioning accuracy enhancements for different scenarios including, for example, those with heavy non-line-of-sight (NLOS)conditions.

These uses cases may be categorized into sub use cases for characterization and baseline performance evaluations. The AI/ML model approaches for the selected sub use cases should be diverse enough to support various requirements on the gNB-UE collaboration levels. The selection of use cases may target the formulation of a framework to apply an AI/ML model to the air-interface for these and other use cases.

An AV/ML model, terminology, and description are developed to identify common and specific characteristics for framework investigations including characterizing the defining stages of AI/ML model related algorithms and associated complexity. These stages include, for example, model generation (e.g., model training (including input/output, pre-/post-process, online/offline as applicable), model validation, model testing, as applicable) and inference operation (e.g., input/output, pre-/post-process, as applicable).

Framework investigations may identify various levels of collaboration between UE and gNB pertinent to the selected use cases including, for example: (1) No collaboration: implementation-based only AI/ML model algorithms without information exchange for comparison purposes, and (2)Various levels of UE/gNB collaboration targeting at separate or joint ML operation. Framework investigations may further characterize lifecycle management of an AI/ML model (e.g., model training, model deployment, model inference, model monitoring, model updating).

Framework investigations may utilize dataset(s) for training, validation, testing, and inference; and identify common notation and terminology for AI/ML model related functions, procedures, and interfaces.

In the related art, specific details and implementations of AI/ML model performance monitoring applicable to Radio Access Network (RAN) procedures are not known or defined. Particularly, after a period of time, AI/ML models may require further training or refinement. Accordingly, the procedures for comparing the performance of AI/ML models with legacy methods are undefined.

### SUMMARY

According to embodiments, systems and methods are provided for implementing mechanisms for AI/ML model performance monitoring in a RAN (e.g., applicable to 3GPP NR).

According to an exemplary embodiment a method performed by at least one processor of a user equipment (UE) includes receiving a set of resources from a base station. The method includes performing a first measuring of the set of resources based on a legacy mode that does not use an artificial intelligence machine learning (AI/ML) model to produce a first output. The method includes performing a second measuring of the set of resources based on the AI/ML model to produce a second output. The method includes reporting, to the base station, results corresponding to the first output and the second output.

According to an exemplary embodiment, a UE includes at least one memory configured to store computer program code, and at least one processor configured to access the at least one memory and operate as instructed by the computer program code. The computer program code includes first receiving code configured to cause at least one of said at least one processor to receive a set of resources from a base station, first performing code configured to cause at least one of said at least one processor to perform a first measuring of the set of resources based on a legacy mode that does not use an artificial intelligence machine learning (AI/ML) model to produce a first output, second performing code configured to cause at least one of said at least one processor to perform a second measuring of the set of resources based on the AIML model to produce a second output, and first reporting code configured to cause at least one of said at least one processor to report, to the base station, results corresponding to the first output and the second output.

According to an exemplary embodiment, a non-transitory computer readable medium having instructions stored therein, which when executed by a processor in UE cause the processor to execute a method that includes receiving a set of resources from a base station. The method includes performing a first measuring of the set of resources based on a legacy mode that does not use an artificial intelligence machine learning (AI/ML) model to produce a first output. The method includes performing a second measuring of the set of resources based on the AI/ML model to produce a second output. The method includes reporting, to the base station, results corresponding to the first output and the second output.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 is a diagram of an example network device, in accordance with various embodiments of the present disclosure.

FIG. 2 is a schematic diagram of an example wireless communications system, in accordance with various embodiments of the present disclosure.

FIG. 3 illustrates a sample time diagram of a flow of events at a user equipment (UE) side, in accordance with one or more embodiments of the present disclosure;

FIGS. 4(A) and (B) illustrate two modes of operation configured in a UE, in accordance with one or more embodiments of the present disclosure; and

FIG. 5 illustrates a flow chart of an embodiment of performing an AI/ML model monitoring process, in accordance with one or more embodiments of the present disclosure.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having.” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Embodiments of the present disclosure are directed to monitoring the AI/ML model and consequent actions taken based on the monitoring output to improve or maintain system performance (e.g., throughput). An AI/ML model may be used for inference at the UE side, network side (e.g., the gNB or in the core network), or at both the UE and the network side. The AI/ML model may be used at the gNB, which does not preclude the cases where the AI/ML model is used at another node in the network that implements the embodiments of the present and the methods similarly.

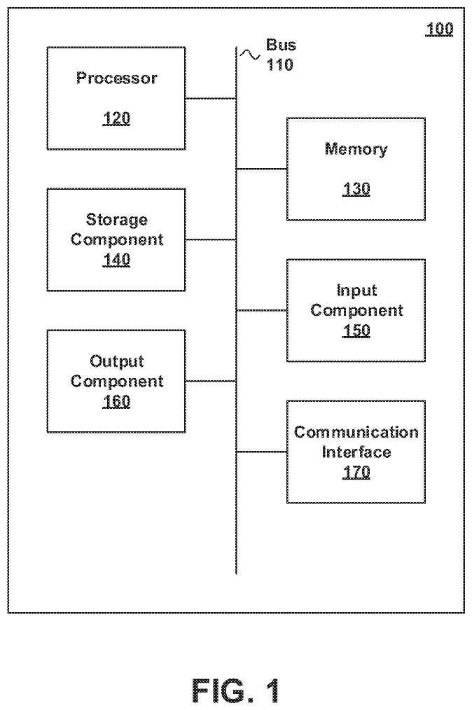

FIG. 1 is diagram of an example device for performing translation services. Device 100 may correspond to any type of known computer, server, or data processing device. For example, the device 100 may comprise a processor, a personal computer (PC), a printed circuit board (PCB) comprising a computing device, a mini-computer, a mainframe computer, a microcomputer, a telephonic computing device, a wired/wireless computing device (e.g., a smartphone, a personal digital assistant (PDA)), a laptop, a tablet, a smart device, or any other similar functioning device.

In some embodiments, as shown in FIG. 1, the device 100 may include a set of components, such as a processor 120, a memory 130, a storage component 140, an input component 150, an output component 160, and a communication interface 170.

The bus 110 may comprise one or more components that permit communication among the set of components of the device 100. For example, the bus 110 may be a communication bus, a cross-over bar, a network, or the like. Although the bus 110 is depicted as a single line in FIG. 1, the bus 110 may be implemented using multiple (two or more) connections between the set of components of device 100. The disclosure is not limited in this regard.

The device 100 may comprise one or more processors, such as the processor 120. The processor 120 may be implemented in hardware, firmware, and/or a combination of hardware and software. For example, the processor 120 may comprise a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any conventional processor, controller, microcontroller, or state machine. The processor 120 also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The processor 120 may control overall operation of the device 100 and/or of the set of components of device 100 (e.g., the memory 130, the storage component 140, the input component 150, the output component 160, and the communication interface 170).

The device 100 may further comprise the memory 130. In some embodiments, the memory 130 may comprise a random access memory (RAM), a read only memory (ROM), an electrically erasable programmable ROM (EEPROM), a flash memory, a magnetic memory, an optical memory, and/or another type of dynamic or static storage device. The memory 130 may store information and/or instructions for use (e.g., execution) by the processor 120.

The storage component 140 of device 100 may store information and/or computer-readable instructions and/or code related to the operation and use of the device 100. For example, the storage component 140 may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

The device 100 may further comprise the input component 150. The input component 150 may include one or more components that permit the device 100 to receive information, such as via user input (e.g., a touch screen, a keyboard, a keypad, a mouse, a stylus, a button, a switch, a microphone, a camera, and the like). Alternatively or additionally, the input component 150 may include a sensor for sensing information (e.g., a global positioning system (GPS) component, an accelerometer, a gyroscope, an actuator, and the like).

The output component 160 of device 100 may include one or more components that may provide output information from the device 100 (e.g., a display, a liquid crystal display (LCD), light-emitting diodes (LEDs), organic light emitting diodes (OLEDs), a haptic feedback device, a speaker, and the like).

The device 100 may further comprise the communication interface 170. The communication interface 170 may include a receiver component, a transmitter component, and/or a transceiver component. The communication interface 170 may enable the device 100 to establish connections and/or transfer communications with other devices (e.g., a server, another device). The communications may be effected via a wired connection, a wireless connection, or a combination of wired and wireless connections. The communication interface 170 may permit the device 100 to receive information from another device and/or provide information to another device. In some embodiments, the communication interface 170 may provide for communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, and the like), a public land mobile network (PLMN), a telephone network (e.g., the Public Switched Telephone Network (PSTN)), or the like, and/or a combination of these or other types of networks. Alternatively or additionally, the communication interface 170 may provide for communications with another device via a device-to-device (D2D) communication link, such as FlashLinQ, WiMedia, Bluetooth, ZigBee, Wi-Fi, LTE, 5G, and the like. In other embodiments, the communication interface 170 may include an Ethernet interface, an optical interface, a coaxial interface, an infrared interface, a radio frequency (RF) interface, or the like.

The device 100 may be included in the core network 240 and perform one or more processes described herein. The device 100 may perform operations based on the processor 120 executing computer-readable instructions and/or code that may be stored by a non-transitory computer-readable medium, such as the memory 130 and/or the storage component 140. A computer-readable medium may refer to a non-transitory memory device. A memory device may include memory space within a single physical storage device and/or memory space spread across multiple physical storage devices.

Computer-readable instructions and/or code may be read into the memory 130 and/or the storage component 140 from another computer-readable medium or from another device via the communication interface 170. The computer-readable instructions and/or code stored in the memory 130 and/or storage component 140, if or when executed by the processor 120, may cause the device 100 to perform one or more processes described herein.

Alternatively, or additionally, hardwired circuitry may be used in place of or in combination with software instructions to perform one or more processes described herein. Thus, embodiments described herein are not limited to any specific combination of hardware circuitry and software.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally or alternatively, a set of (one or more) components shown in FIG. 1 may perform one or more functions described as being performed by another set of components shown in FIG. 1.

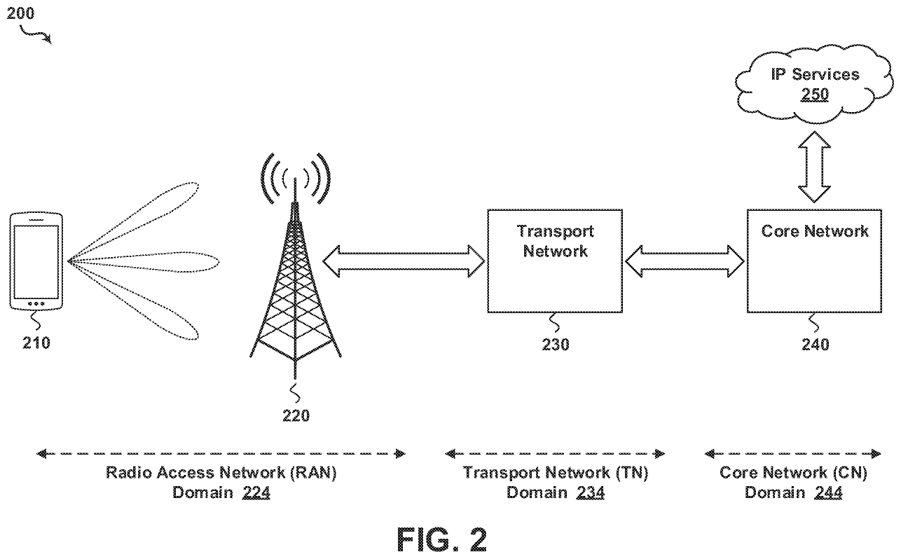

FIG. 2 is a diagram illustrating an example of a wireless communications system, according to various embodiments of the present disclosure. The wireless communications system 200 (which may also be referred to as a wireless wide area network (WWAN)) may include one or more user equipment (UE) 210, one or more base stations 220, at least one transport network 230, and at least one core network 240. The device 100 (FIG. 1) may be incorporated in the UE 210 or the base station 220.

The one or more UEs 210 may access the at least one core network 240 and/or IP services 250 via a connection to the one or more base stations 220 over a RAN domain 224 and through the at least one transport network 230. Examples of UEs 210 may include a cellular phone, a smart phone, a session initiation protocol (SIP) phone, a laptop, a personal digital assistant (PDA), a satellite radio, a global positioning system (GPS), a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similarly functioning device. Some of the one or more UEs 210 may be referred to as Internet-of-Things (loT) devices (e.g., parking meter, gas pump, toaster, vehicles, heart monitor, etc.). The one or more UEs 210 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile agent, a client, or some other suitable terminology.

The one or more base stations 220 may wirelessly communicate with the one or more UEs 210 over the RAN domain 224. Each base station of the one or more base stations 220 may provide communication coverage to one or more UEs 210 located within a geographic coverage area of that base station 220. In some embodiments, as shown in FIG. 2, the base station 220 may transmit one or more beamformed signals to the one or more UEs 210 in one or more transmit directions. The one or more UEs 210 may receive the beamformed signals from the base station 220 in one or more receive directions. Alternatively or additionally, the one or more UEs 210 may transmit beamformed signals to the base station 220 in one or more transmit directions. The base station 220 may receive the beamformed signals from the one or more UEs 210 in one or more receive directions.

The one or more base stations 220 may include macrocells (e.g., high power cellular base stations) and/or small cells (e.g., low power cellular base stations). The small cells may include femtocells, picocells, and microcells. A base station 220, whether a macrocell or a large cell, may include and/or be referred to as an access point (AP), an evolved (or evolved universal terrestrial radio access network (E-UTRAN)) Node B (eNB), a next-generation Node B (gNB), or any other type of base station known to one of ordinary skill in the art.

The one or more base stations 220 may be configured to interface (e.g., establish connections, transfer data, and the like) with the at least one core network 240 through at least one transport network 230. In addition to other functions, the one or more base stations 220 may perform one or more of the following functions: transfer of data received from the one or more UEs 210 (e.g., uplink data) to the at least one core network 240 via the at least one transport network 230, transfer of data received from the at least one core network 240 (e.g., downlink data) via the at least one transport network 230 to the one or more UEs 210.

The transport network 230 may transfer data (e.g., uplink data, downlink data) and/or signaling between the RAN domain 224 and the CN domain 244. For example, the transport network 230 may provide one or more backhaul links between the one or more base stations 220 and the at least one core network 240. The backhaul links may be wired or wireless.

The core network 240 may be configured to provide one or more services (e.g., enhanced mobile broadband (eMBB), ultra-reliable low-latency communications (URLLC), and massive machine type communications (mMTC), etc.) to the one or more UEs 210 connected to the RAN domain 224 via the TN domain 234. As an example, the core network 240 performs the translation service. Alternatively or additionally, the core network 240 may serve as an entry point for the IP services 250. The IP services 250 may include the Internet, an intranet, an IP multimedia subsystem (IMS), a streaming service (e.g., video, audio, gaming, etc.), and/or other IP services.

An AI/ML model may be used in various scenarios. For example, a two-sided AI/ML model may be used at the gNB side for encoder functions (e.g., compression, CSI compression, etc.) and at the UE side for decoder functions (e.g., decompression). In another example, an AI/ML model may be used at the UE side to predict a set of beams in time and/or spatial domains. For example, the UE may measure a first set of beams and may predict a second set of beams using the measurements as an input to the AI/ML model. In other examples, an AI/ML model may be used at the network side to predict a UE position using a set of measurements which may be reported by the UE. To perform the specific inference in a scenario, the UE and/or the network may perform measurements (e.g., measurements of reference signals) to predict a best set of resources (e.g., beams). When inference is performed at the network side, the measurement results may be reported by the UE to the network, or measurements may be performed at the network side.

The quality of the AI/ML model inference may be monitored. The quality of the AI/ML model inference may be determined by a key performance indicator (KPI) of the system when the inference is used in the system (e.g., in a transmission scheme). For example, a UE may receive a set of beams (e.g., 64 beams), measure a subset of the received beams (e.g., 8 beams), and infer a best beam for DL transmission and let the gNB know this beam. The gNB may use this beam for transmission to the UE. The UE may compare a system KPI (e.g., block error rate (BLER), throughout, spectral efficiency) when the inferred beam is used with a KPI when a beam determined using legacy methods is used. If the KPI of the beam determined using the legacy methods is higher than the KPI of the inferred beam, it may be determined that the AI/ML model may require further training or refining.

In another example, the quality of the model inference may be measured by comparing the accuracy of the inference with respect to an accuracy of a reference signal. For example, the CSI at the output of the AI/ML model based decoder at the gNB may be compared to the CSI estimated and reported by the UE using legacy methods. A predefined metric (e.g., mean square error (MSE), a metric to measure the difference) may be used to determine the accuracy of an AUML model. Other metrics may also be used to monitor the AIML model performance. For example, the metric may be the difference in the reference signal received power (RSRP), etc.

In some embodiments, the mode of a procedure (e.g., a transmission mode) may be determined by whether an AI/ML model is used for the procedure, and further, the AI/ML model ID. For example, in a first transmission mode, the MCS may be determined using legacy methods without the AI/ML model; in a second transmission mode, the MCS may be determined using CSI from AI/ML model #0; and in a third mode, the MCS may be determined using CSI from AI/ML model #1.

A system KPI may be evaluated at the UE or the gNB. In some examples, the UE may calculate the BLER, throughput, etc., and feedback the KPIs and/or a function of the KPIs (e.g., difference in KPIs) to the gNB. In other examples, the gNB may calculate the KPI using feedback from the UE. For example, the gNB may calculate a KPI using hybrid automatic repeat request (HARQ) feedback from the UE. The model accuracy evaluation may be a UE capability. For example, the UE may be configured to perform model performance evaluation.

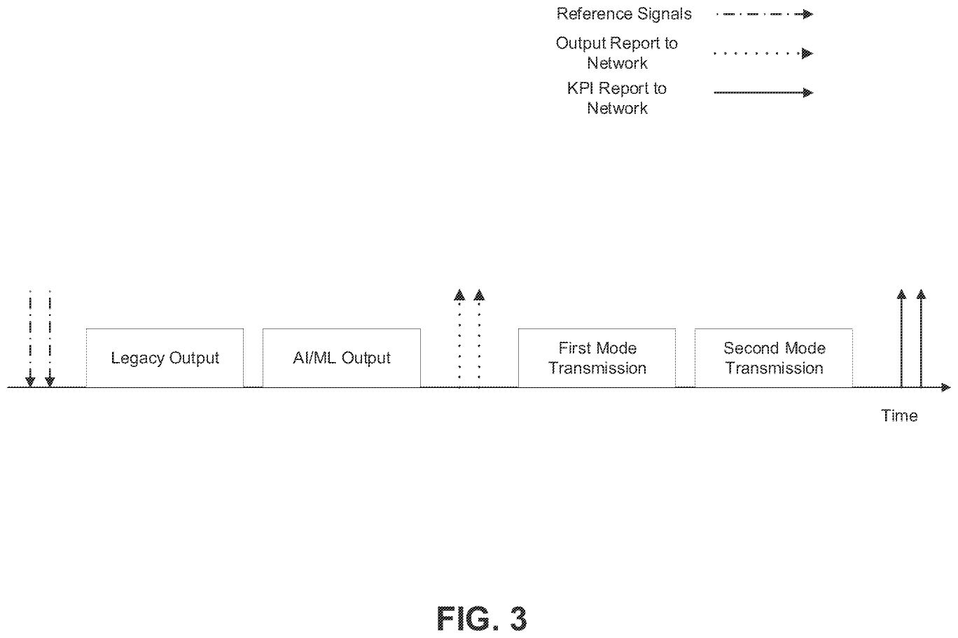

According to some embodiments, AI/ML model monitoring may comprise multiple phases. A sample time diagram of a flow of events at the UE side is illustrated in FIG. 3. In the first phase, after receiving a set of resources from a base station (e.g., reference signals) the UE may generate a plurality of outputs. An output may be a measurement of, for example, the RSRP of a beam, the CSI, channel impulse response (CIR), etc. Although two outputs are illustrated in FIG. 3, the number of outputs may be one or more than two. One output may be determined using legacy methods, and another output may be determined using an AI/ML model to generate an inference. In some examples, more than one AI/ML model output corresponding to different models may be generated.

The UE may use reference signal measurements to generate the outputs. For example, for CSI estimation, the UE may use CSI-RS resources. The legacy output may be the CSI estimate and the AI/ML model output may be the AI/ML model encoder output that may represent a compressed version of the estimated CSI. In this example, the same reference signal may be used for generating both outputs. In another example, the legacy output may be the best N downlink beams estimated using reference signals, for example, synchronization signal blocks (SSBs) or CSI-RSs. The AIML model output may be the best K beams (e.g., N may be equal to K) estimated using a subset of the reference signals. In a third example, the legacy output may be a time of arrival estimation using position reference signals (PRSs), and the AI/ML model output may be a time of arrival inference using the CIR. In some examples, the AI/ML model output may not be at the UE side (e.g., UE does not perform inference). The UE may generate one or more outputs (e.g., time of arrival estimation and CIR) using one or more reference signals.

In the second phase, the outputs may be reported to the network. In the third phase, the gNB may perform transmission (e.g., data transmission) to the UE in a first mode and in a second mode. The number of modes is not limited to two. The transmission parameters of the first mode may be determined from the first output, and the transmission parameters of the second mode may be determined from the second output, which may be referred to as association. Using the example above, the first mode may use the modulation coding scheme (MCS) determined from the legacy CSI output, and the second mode may use the MCS determined from CSI inference of the AI/ML model. The final inference may be performed at the UE or the gNB side. The UE may be indicated on which resources to receive the different modes of transmission. Subsequently, the UE may calculate the KPIs of the different modes of transmission (e.g., BLER, throughout, etc.) and may feedback the KPIs to the network. The KPIs may be fed back separately or in the same report. Depending on the particular use case being used, one or more of these phases may not exist. For example, in a positioning use case, the network may determine the UE position based on the outputs fed back from the UE.

In some embodiments, a UE may be configured to report output results in at least one of periodic, aperiodic, semi-static manner. For a report, a UE may be configured with one or more of the following:
One or a plurality of signals to calculate the reference output (legacy output);
One or a plurality of signals to that may be used as an input to the AI/ML model (AI/ML model may be at the UE side, network side, or both);
Reporting resources (e.g., time and frequency resources, channel to be used such as physical uplink control channel (PUCCH), physical uplink shared channel (PUSCH), or media access control (MAC) CE; report format, report quantity (e.g., RSRP, etc.));
A mapping between the report to signals;
A mapping between the AI/ML model and the signal; and
A mapping between the report and the AI/ML model.

The mapping between the transmission mode and the output associated to that mode may be indicated to the UE explicitly and/or implicitly using one or more of the following, or a combination of the following:
Codepoint(s) in downlink control information (DCI) may indicate the mapping. For example, 00: transmission associated to legacy output; 01: transmission associated to AI/ML model #0; 10: transmission associated to AI/ML model #1.
Radio network temporary identifier (RNTI).
Time/frequency resources.
Bandwidth part (BWP)
Physical downlink control channel (PDCCH) parameter (control resource set (CORESET) ID, search space ID, etc.)

The data used in the transmission modes (e.g., first mode transmission second mode transmission in FIG. 3) may be the same. In some examples, HARQ may be disabled. In some examples, KPIs may be averaged and/or filtered.

In some embodiments, a UE may be provided with a configuration for AI/ML model monitoring. The configuration may include parameters for AI/ML model inference (e.g., model input, resources over which the inputs are measured, AI/ML model ID, use case, a time interval during which monitoring may be performed, etc.) and/or parameters needed for reporting. Example use cases include, but are not limited to, using an AI/ML model for CSI compression or beam prediction. Monitoring may be performed in a periodic manner, semi-static manner or in an aperiodic manner. Reporting may be periodic, semi-static, or aperiodic. Reporting may be output reporting and/or KPI reporting.

An output report configuration may include a specific output type (e.g., a legacy output, an output from a specific AI/ML model), reference signals from which the outputs are derived, a time window in which the outputs are derived, etc. A KPI report configuration may include a KPI type (e.g., BLER, throughput, etc.), the transmission to which the KPIis associated (e.g., the association may be by defining resources in which the transmission takes place), AI/ML model ID, etc.

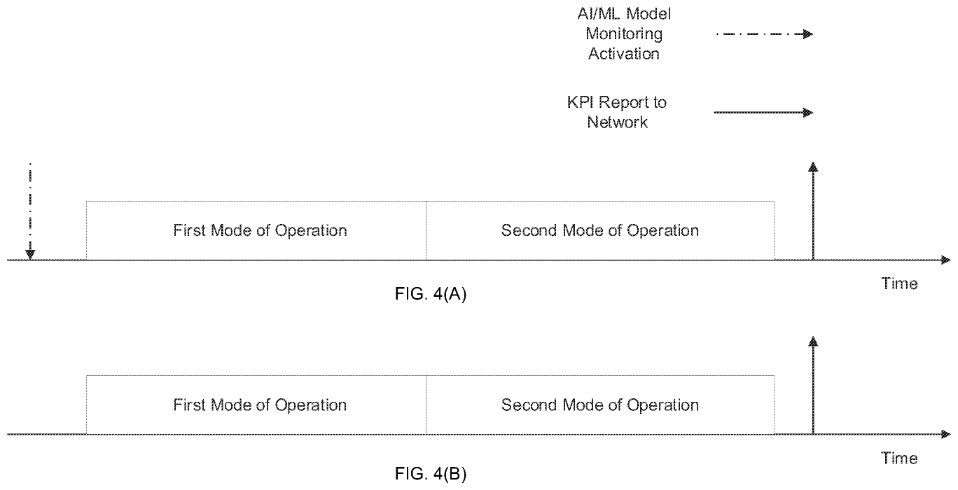

According to some embodiments, a UE may be configured to operate, or may be operating in a first mode as shown in FIG. 4(A).

For example, as illustrated in FIG. 4(A), a UE may receive an indication for model monitoring activation. The indication may be carried in a MAC control element (CE) or in a DCI. Information included in the MAC CE may indicate which AI/ML model to monitor (e.g., model ID), which KPI to use, whether filtering is used, filter parameters, length of observation, etc. In some examples, monitoring parameters may be configured, where DCI and/or MAC CE may be used to indicate a specific configuration.

A KPI for first mode of operation may be calculated and stored. For example, the interval of monitoring for each mode may be one discontinuous reception (DRX) cycle. A KPI for second mode of operation may be calculated and stored. The KPIs may be fedback in the same or different reports. The reporting configuration may be performed by a radio resource control (RRC). For example, the time instance when the KPI report(s) are transmitted may be known and may use the time of monitoring activation as a reference.

In other examples, as illustrated in FIG. 4(B), the KPI reporting may be configured where explicit monitoring activation is not needed. For example, KPIs may be reported periodically. The resources for different modes of operation may be configured according to the periodic KPI reporting. For example, the time in which first mode and second mode transmissions take place may be known to the UE based on the KPI reporting (e.g., UE performs first mode and second mode transmissions at a timing before the KPI reporting is scheduled). In some examples, there may be separate KPI reports for separate transmission modes.

According to some embodiments, model monitoring scheme may be changed depending on whether any of the monitoring KPIs are larger or smaller than a configured threshold for a certain period. For example, after model selection/switching, since the parameter adaptation may not be enough, the resulting KPI may become worse. Therefore, the UE or network may configure a shorter monitoring period, and after a certain period, model monitoring period may be made shorter. In other examples, when the BLER is larger than a configured threshold for a certain period, the network or UE may configure a monitoring period to a shorter value so that model switching may be performed as early as possible when any of the KPI become worse than a threshold.

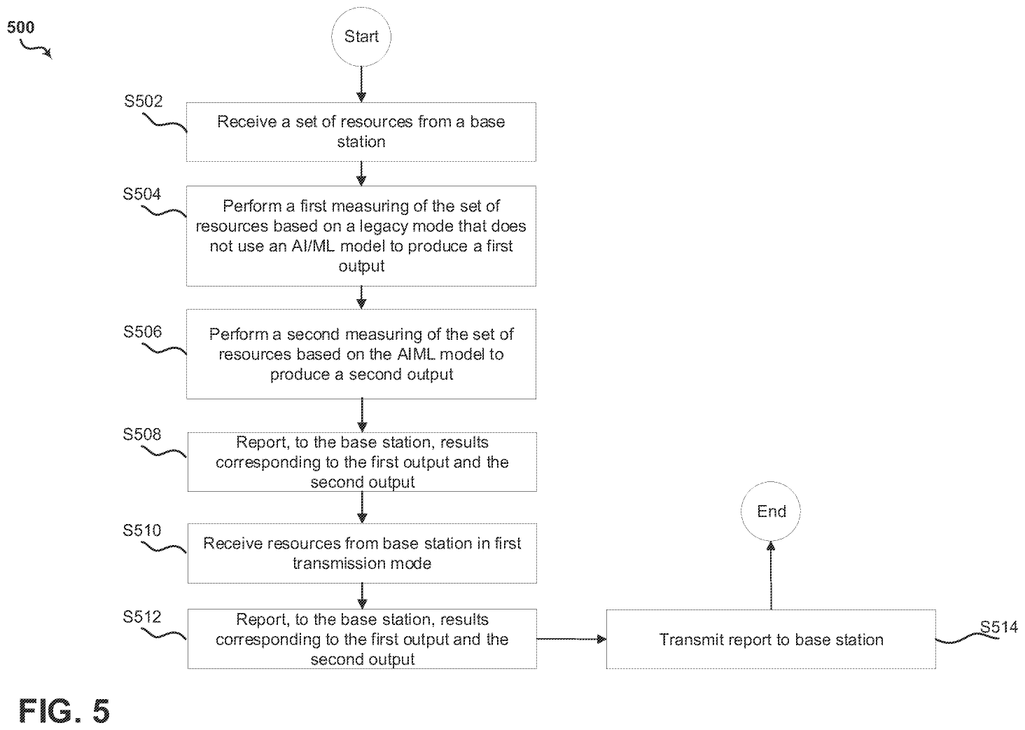

FIG. 5 illustrates a flowchart of an embodiment of an AI/ML model monitoring process 500. The process may start at operation S502 where a set of resources are received from a base station. The set of resources may be one or more beams or CSI-RS resources. The process proceeds to operation S504 where a first measuring of the set of resources is performed based on a legacy mode that does not use an AI/ML model to produce a first output. The process proceeds to operation S506 where a second measuring of the set of resources is performed based on the AI/ML model to produce a second output. For example, where the one or more resources are beams, the legacy mode may measure each received beam (e.g., 64) while the AI/ML model measures a subset of the received beams (e.g., 8) to predict the best beams. As another example, where the one or more resources are CSI-RS resources, the legacy mode may provide an estimated CSI as the first output, and the AI/ML model may provide another estimated CSI obtained from the input of the compressed version of the CSI-RS resources as the second output. The process proceeds to operation S508 where the results corresponding to the first output and the second output are reported to the base station. The results may be the measurements where, for example, the base station determines the best beams. In another example, the UE may determine the best beams based on the first output and the best beams based on the second output, which are reported to the base station. For example, using the legacy methods, the UE may determine a first set of beams as the best beams, and using the AI/ML model, the UE determines a second set of beams as the best beams, where the first set of beams and the second set of beams are reported to the base station.

The process proceeds to operation S510 where the UE receives resources from the base station in a first transmission mode. The process proceeds to operation S512 where the UE receives resources from the base station in a second transmission mode. For example, in the first transmission mode, the base station may transmit reference signals in accordance with the first set of beams determined using the legacy methods, and in the second transmission mode, the base station may transmit reference signals in accordance with the second set of beams determined using the AI/ML model. The operation proceeds to operation S514 where the UE transmits a report to the base station. For example, the report may be a KPI report that reports the results of the measurements from the first transmission mode and the second transmission mode.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

### ABBREVIATIONS

AI/ML Artificial intelligence/machine learning
BLER Block error rate
BWP Bandwidth part
CE Control Element
CORESET Control resource set
CQI Channel quality indicator
CIR Channel impulse response
CRI CSI-RS Resource Indicator
CSI Channel state information
CSI-RS Channel state information reference signal
CSI-RSRP CSI reference signal received power
CSI-RSRQ CSI reference signal received quality
CSI-SINR CSI signal-to-noise and interference ratio
DCI Downlink control information
DL Downlink
DM-RS Demodulation reference signals
DRX Discontinuous reception
HARQ Hybrid automatic repeat request
KPI Key Performance Indicator
L1-RSRP Layer 1 reference signal received power
LI Layer Indicator
MAC Media access control
MCS Modulation and coding scheme
MSE Mean square error
NLOS non-line-of-site
NR New Radio
PDCCH Physical downlink control channel
PDSCH Physical downlink shared channel
PSS Primary Synchronization signal
PUCCH Physical uplink control channel
PUSCH Physical uplink shared channel
QCL Quasi co-location
PMI Precoding Matrix Indicator
PRB Physical resource block
PRG Precoding resource block group
PRS Positioning reference signal
RAN Radio access network
RB Resource block
RBG Resource block group
RNTI Radio network temporary identifier
RI Rank Indicator
RRC Radio Resource Control
RS Reference signal
SID Study item description
SS Synchronization signal
SSB Synchronization signal block
SSS Secondary Synchronization signal
SS-RSRP SS reference signal received power
SS-RSRQ SS reference signal received quality
SS-SINR SS signal-to-noise and interference ratio
TCI Transmission Configuration Indicator
TDM Time division multiplexing
UE User equipment

### UL Uplink

The above disclosure also encompasses the embodiments listed below:

(1) A method performed by at least one processor of a user equipment (UE), the method including: receiving a set of resources from a base station; performing a first measuring of the set of resources based on a legacy mode that does not use an artificial intelligence machine learning (AI/ML) model to produce a first output; performing a second measuring of the set of resources based on the AI/ML model to produce a second output; and reporting, to the base station, results corresponding to the first output and the second output.

(2) The method according to feature (1), in which the set of resources from the base station includes one or more channel state information reference signal (CSI-RS) resources, in which the first output is an estimated CSI, and in which the second output is another estimated CSI obtained from the input of compressed version of the CSI-RS resources.

(3) The method according to feature (2), further including: based on the reporting: receiving, from the base station during a first transmission mode, the one or more CSI-RS resources using a first modulation coding scheme (MCS) determined based on the first output; receiving, from the base station during a second transmission mode, the one or more CSI-RS resources using a MCS determined based on the second output; determining a first set of key performance indicators (KPIs) corresponding to the first transmission mode; determining a second set of KPIs corresponding to the second transmission mode; and reporting the first set of KPIs and the second set of KPIs to the base station.

(4) The method according to feature (1), in which the set of resources from the base station include a plurality of beams, in which the first output includes a reference signal received power (RSRP) of each of the plurality of beams, in which the second output includes a RSRP of a subset of the plurality of beams, in which N best beams are determined based on the first output, in which M best beams are determined based on the second output, in which N and M are integers greater than zero.

(5) The method according to feature (4), further including: determining the N best beams based on the first output; and determining the M best beams based on the second output, in which the reporting the results to the base station include reporting the N best beams and the M best beams.

(6) The method according to feature (4), in which the base station determines the N best beams and the M best beams based on the reporting.

(7) The method according to feature (4), further including performing, during a first transmission mode, a third measuring of the N best beams based on the legacy mode; performing, during a second transmission mode, a fourth measuring of the M best beams based on the AI/ML model; determining a first set of key performance indicators (KPIs) based on the third measuring; determining a second set of KPIs based on the fourth measuring; and reporting, to the base station, the first set of KPIs and the second set of KPIs.

(8) The method according to feature (1), in which the set of resources include one or more positioning reference signals (PRSs) and a channel impulse response (CIR), in which the first output is a time of arrival estimation of the UE using the one or more PRSs, in which the second output is a time of arrival inference using the CIR, and in which the base station determines a position of the UE based on the reporting.

(9) The method according to feature (1), further including: receiving, from the base station, a measurement activation signal; and performing the first measuring and the second measuring based on the reception of the measurement activation signal.

(10) The method according to feature (1), in which the reporting of the results corresponding to the first output and the second output is performed at a predetermined timing, and in which the first measuring and the second measuring are performed at a timing in accordance with the predetermined timing.

(11) The method according to feature (1), further including receiving, from the base station, an indication of which AV/ML model to use from a plurality of AI/ML models for the second measuring.

(12) A user equipment (UE) including: at least one memory configured to store computer program code; and at least one processor configured to access said at least one memory and operate as instructed by the computer program code, the computer program code including: first receiving code configured to cause at least one of said at least one processor to receive a set of resources from a base station, first performing code configured to cause at least one of said at least one processor to perform a first measuring of the set of resources based on a legacy mode that does not use an artificial intelligence machine learning (AI/ML) model to produce a first output, second performing code configured to cause at least one of said at least one processor to perform a second measuring of the set of resources based on the AI/ML model to produce a second output, and first reporting code configured to cause at least one of said at least one processor to report, to the base station, results corresponding to the first output and the second output.

(13) The UE according to feature (12), in which the set of resources from the base station includes one or more channel state information reference signal (CSI-RS) resources, in which the first output is an estimated CSI, and in which the second output is another estimated CSI obtained from the input of compressed version of the CSI-RS resources.

(14) The UE according to feature (12), in which the computer program code includes: second receiving code, third receiving code, first determining code, second determining code, and second reporting code, in which based on the reporting: the second receiving code is configured to cause at least one of said at least one processor to receive, from the base station during a first transmission mode, the one or more CSI-RS resources using a first modulation coding scheme (MCS) determined based on the first output, the third receiving code is configured to cause at least one of said at least one processor to receive, from the base station during a second transmission mode, the one or more CSI-RS resources using a MCS determined based on the second output; the first determining configured to cause at least one of said at least one processor to determine a first set of key performance indicators (KPIs) corresponding to the first transmission mode, the second determining configured to cause at least one of said at least one processor to determine a second set of KPIs corresponding to the second transmission mode, and the second reporting configured to cause at least one of said at least one processor to report the first set of KPIs and the second set of KPIs to the base station.

(15) The UE according to feature (12), in which the set of resources from the base station include a plurality of beams, in which the first output includes a reference signal received power (RSRP) of each of the plurality of beams, in which the second output includes a RSRP of a subset of the plurality of beams, in which N best beams are determined based on the first output, in which M best beams are determined based on the second output, in which N and M are integers greater than zero.

(16) The UE according to feature (15), in which the computer program code further includes: first determining code configured to cause at least one of said at least one processor to determine the N best beams based on the first output; and second determining configured to cause at least one of said at least one processor to determine the M best beams based on the second output, in which the first reporting code is further configured to cause at least one of said at least one processor to report the results to the base station include reporting the N best beams and the M best beams.

(17) The UE according to feature (15), in which the base station determines the N best beams and the M best beams based on the reporting.

(18) The UE according to feature (15), in which the computer program code further includes: third performing code configured to cause at least one of said at least one processor to perform, during a first transmission mode, a third measuring of the N best beams based on the legacy mode; fourth performing code configured to cause at least one of said at least one processor to perform, during a second transmission mode, a fourth measuring of the M best beams based on the AI/ML model, first determining configured to cause at least one of said at least one processor to determine a first set of key performance indicators (KPIs) based on the third measuring; second determining configured to cause at least one of said at least one processor to determine a second set of KPIs based on the fourth measuring, and second reporting configured to cause at least one of said at least one processor to report, to the base station, the first set of KPIs and the second set of KPIs.

(19) The UE according to feature (12), in which the set of resources include one or more positioning reference signals (PRSs) and a channel impulse response (CIR), in which the first output is a time of arrival estimation of the UE using the one or more PRSs, in which the second output is a time of arrival inference using the CIR, and in which the base station determines a position of the UE based on the reporting.

(20) A non-transitory computer readable medium having instructions stored therein, which when executed by a processor in a user equipment (UE) cause the processor to execute a method including: receiving a set of resources from a base station; performing a first measuring of the set of resources based on a legacy mode that does not use an artificial intelligence machine learning (AI/ML) model to produce a first output; performing a second measuring of the set of resources based on the AI/ML model to produce a second output; and reporting, to the base station, results corresponding to the first output and the second output.

What is claimed:

1. A method performed by at least one processor of a user equipment (UE), the method comprising:
receiving a set of resources from a base station;
performing a first measuring of the set of resources based on a legacy mode that does not use an artificial intelligence machine learning (AI/ML) model to produce a first output;
performing a second measuring of the set of resources based on the AI/ML model to produce a second output; and
reporting, to the base station, results corresponding to the first output and the second output.

2. The method according to claim 1,
wherein the set of resources from the base station includes one or more channel state information reference signal (CSI-RS) resources,
wherein the first output is an estimated CSI, and
wherein the second output is another estimated CSI obtained from the input of compressed version of the CSI-RS resources.

3. The method according to claim 2, further comprising:
based on the reporting:
receiving, from the base station during a first transmission mode, the one or more CSI-RS resources using a first modulation coding scheme (MCS) determined based on the first output;
receiving, from the base station during a second transmission mode, the one or more CSI-RS resources using a MCS determined based on the second output;
determining a first set of key performance indicators (KPIs) corresponding to the first transmission mode;
determining a second set of KPIs corresponding to the second transmission mode; and
reporting the first set of KPIs and the second set of KPIs to the base station.

4. The method according to claim 1,
wherein the set of resources from the base station include a plurality of beams,
wherein the first output includes a reference signal received power (RSRP) of each of the plurality of beams,
wherein the second output includes a RSRP of a subset of the plurality of beams,
wherein N best beams are determined based on the first output,
wherein M best beams are determined based on the second output,
wherein N and M are integers greater than zero.

5. The method according to claim 4, further comprising:
determining the N best beams based on the first output; and
determining the M best beams based on the second output,
wherein the reporting the results to the base station include reporting the N best beams and the M best beams.

6. The method according to claim 4, wherein
the base station determines the N best beams and the M best beams based on the reporting.

7. The method according to claim 4, further comprising:
performing, during a first transmission mode, a third measuring of the N best beams based on the legacy mode;
performing, during a second transmission mode, a fourth measuring of the M best beams based on the AI/ML model;
determining a first set of key performance indicators (KPIs) based on the third measuring;
determining a second set of KPIs based on the fourth measuring; and
reporting, to the base station, the first set of KPIs and the second set of KPIs.

8. The method according to claim 1,
wherein the set of resources include one or more positioning reference signals (PRSs) and a channel impulse response (CIR),
wherein the first output is a time of arrival estimation of the UE using the one or more PRSs,
wherein the second output is a time of arrival inference using the CIR, and
wherein the base station determines a position of the UE based on the reporting.

9. The method according to claim 1, further comprising:
receiving, from the base station, a measurement activation signal; and
performing the first measuring and the second measuring based on the reception of the measurement activation signal.

10. The method according to claim 1,
wherein the reporting of the results corresponding to the first output and the second output is performed at a predetermined timing, and
wherein the first measuring and the second measuring are performed at a timing in accordance with the predetermined timing.

11. The method according to claim 1, further comprising:
receiving, from the base station, an indication of which AI/ML model to use from a plurality of AI/ML models for the second measuring.

12. A user equipment (UE) comprising:
at least one memory configured to store computer program code; and
at least one processor configured to access said at least one memory and operate as instructed by the computer program code, the computer program code including:
first receiving code configured to cause at least one of said at least one processor to receive a set of resources from a base station,
first performing code configured to cause at least one of said at least one processor to perform a first measuring of the set of resources based on a legacy mode that does not use an artificial intelligence machine learning (AI/ML) model to produce a first output,
second performing code configured to cause at least one of said at least one processor to perform a second measuring of the set of resources based on the AUML model to produce a second output, and
first reporting code configured to cause at least one of said at least one processor to report, to the base station, results corresponding to the first output and the second output.

13. The UE according to claim 12,
wherein the set of resources from the base station includes one or more channel state information reference signal (CSI-RS) resources,
wherein the first output is an estimated CSI, and
wherein the second output is another estimated CSI obtained from the input of compressed version of the CSI-RS resources.

14. The UE according to claim 12, wherein the computer program code includes:
second receiving code, third receiving code, first determining code, second determining code, and second reporting code,
wherein based on the reporting:
the second receiving code is configured to cause at least one of said at least one processor to receive, from the base station during a first transmission mode, the one or more CSI-RS resources using a first modulation coding scheme (MCS) determined based on the first output,
the third receiving code is configured to cause at least one of said at least one processor to receive, from the base station during a second transmission mode, the one or more CSI-RS resources using a MCS determined based on the second output;
the first determining configured to cause at least one of said at least one processor to determine a first set of key performance indicators (KPIs) corresponding to the first transmission mode,
the second determining configured to cause at least one of said at least one processor to determine a second set of KPIs corresponding to the second transmission mode, and
the second reporting configured to cause at least one of said at least one processor to report the first set of KPIs and the second set of KPIs to the base station.

15. The UE according to claim 12,
wherein the set of resources from the base station include a plurality of beams,
wherein the first output includes a reference signal received power (RSRP) of each of the plurality of beams,
wherein the second output includes a RSRP of a subset of the plurality of beams,
wherein N best beams are determined based on the first output,
wherein M best beams are determined based on the second output,
wherein N and M are integers greater than zero.

16. The UE according to claim 15, wherein the computer program code further includes:
first determining code configured to cause at least one of said at least one processor to determine the N best beams based on the first output; and
second determining configured to cause at least one of said at least one processor to determine the M best beams based on the second output,
wherein the first reporting code is further configured to cause at least one of said at least one processor to report the results to the base station include reporting the N best beams and the M best beams.

17. The UE according to claim 15, wherein
the base station determines the N best beams and the M best beams based on the reporting.

18. The UE according to claim 15, wherein the computer program code further includes:
third performing code configured to cause at least one of said at least one processor to perform, during a first transmission mode, a third measuring of the N best beams based on the legacy mode;
fourth performing code configured to cause at least one of said at least one processor to perform, during a second transmission mode, a fourth measuring of the M best beams based on the AUML model,
first determining configured to cause at least one of said at least one processor to determine a first set of key performance indicators (KPIs) based on the third measuring;
second determining configured to cause at least one of said at least one processor to determine a second set of KPIs based on the fourth measuring, and
second reporting configured to cause at least one of said at least one processor to report, to the base station, the first set of KPIs and the second set of KPIs.

19. The UE according to claim 12,
wherein the set of resources include one or more positioning reference signals (PRSs) and a channel impulse response (CIR),
wherein the first output is a time of arrival estimation of the UE using the one or more PRSs,
wherein the second output is a time of arrival inference using the CIR, and
wherein the base station determines a position of the UE based on the reporting.

20. A non-transitory computer readable medium having instructions stored therein, which when executed by a processor in a user equipment (UE) cause the processor to execute a method comprising:
receiving a set of resources from a base station;
performing a first measuring of the set of resources based on a legacy mode that does not use an artificial intelligence machine learning (AI/ML) model to produce a first output;
performing a second measuring of the set of resources based on the AI/ML model to produce a second output; and
reporting, to the base station, results corresponding to the first output and the second output.
